(19) United States
(12) Patent Application Publication
(10) Pub. No.: US 2015/0007238 A1
(43) Pub. Date: Jan. 1, 2015

(54) SYSTEMS AND MEHTODS FOR CONTENT STREAMING TO EVENT SPECTATORS

(71) Applicant: Delaware General Corporation, Daytona Beach, FL (US)

(72) Inventors: Gene Crouch, Daytona Beach, FL (US); Robert Fitzsimmons, DeLand, FL (US)

(21) Appl. No.: 13/927,806

(22) Filed: Jun. 26, 2013

(51) Int. Cl. H04N 21/218; H04N 21/472; H04N 21/2187

(52) U.S. Cl. CPC H04N 21/21805; H04N 21/2187; H04N 21/47202
USPC 725/93; 348/148

(57) ABSTRACT

Systems, apparatuses, and methods are provided according to example embodiments to provide interactive content streaming systems able to deliver audio and video content from a variety of venues to event spectators. One embodiment is provided that at least includes a distribution server and one or more venue systems, each located at a site and each comprising one or more remote camera units, a wireless access point, and a site-located router. The one or more remote camera units may be configured at least to capture video and audio content, encode and buffer the captured content, and transmit the encoded content to the site-located router via the wireless access point. The site-located router may be configured at least to receive one or more streams of encoded content from the one or more remote camera units and transmit the encoded streams to the distribution server. The distribution server may be configured at least to receive one or more encoded streams from the one or more venue systems, provide an interface for the selection of one of the one or more encoded streams, and transmit the selected encoded stream to a user device.

### TECHNOLOGICAL FIELD

An example embodiment of the present invention relates generally to the capture, transmission, and presentation of streaming content, and more particularly to capturing, compressing, and encoding streams of audio/video content at one or more venues and transmitting the streams of audio/video content to a distribution system for presentation to event spectators.

### BACKGROUND

The modern communications era has brought about a tremendous expansion of wireless networks. Concurrent with the expansion of networking technologies, an expansion in computing power has resulted in the development of affordable computing devices capable of taking advantage of services made possible by modern networking technologies. This expansion in computing power has also led to a reduction in the size of computing devices and given rise to new generations of mobile devices and video devices that are capable of performing functionality that once required processing power that could be provided only by the most advanced desktop computers and video systems.

Along with this expansion in capabilities and reduction in size of computing devices, consumer demand for various types of content has also grown. As such, the ability to easily provide streaming of digital content to users at lower costs has become more desirable. For example, it is becoming important for content providers, such as the motorsports industry, to be able to provide real-time content streaming of audio/video content from various venues, such as during racing events, and from various sources.

Additionally, in fields such as motorsports, being able to capture and transmit real-time video wirelessly from a high-speed moving vehicle is becoming more desirable and important, particularly for the purpose of retransmission over television broadcast networks and the Internet.

A number of deficiencies and problems associated with providing streaming of audio and video from a variety of event venues are identified herein. Through applied effort, ingenuity, and innovation, exemplary solutions to many of these identified problems are embodied by the present invention, which is described in detail below.

### BRIEF SUMMARY

Systems, apparatuses, and methods are therefore provided according to example embodiments of the present invention to provide interactive content streaming systems delivering audio and video content from venues to event spectators.

In one embodiment, a system is provided that at least includes a distribution server and one or more venue systems, each located at a site and each comprising one or more remote camera units, one or more wireless access points, and a site-located router. The one or more remote camera units may be configured at least to capture audio/video content, encode and buffer the captured audio/video content, and transmit the encoded audio/video content to the site-located router via the one or more wireless access points. The site-located router may be configured at least to receive one or more streams of encoded audio/video content from the one or more remote camera units via the one or more wireless access points and transmit the encoded streams to the distribution server. The distribution server may be configured at least to receive one or more encoded streams from the one or more venue systems, provide an interface for the selection of one of the one or more encoded streams, and transmit the selected encoded stream to a user device.

In some embodiments, the site-located router may be further configured to combine multiple network connections for transmitting the one or more encoded streams to the distribution server.

In some embodiments, the interface may provide for the selection of one of the one or more sites and then provides for selection of the one or more encoded streams transmitted from the selected site.

In some embodiments, the one or more venue systems may further include a Global Positioning System (GPS) device configured to provide location data to be transmitted along with the one or more encoded streams to the distribution server, and the distribution server may be further configured to provide the interface for the selection of one of the one or more encoded streams, the interface displaying the one or more encoded streams for selection based in part on the location data.

In some embodiments, the system may further comprise a site-located encoding server at least configured to receive one or more streams of encoded audio/video content from the one or more remote camera units; receive other audio/video content from one or more sources other than the one or more remote camera units; combine the other audio/video content with one or more of the streams of encoded audio/video content from the one or more remote camera units; encode the combined content; and transmit the encoded content to the site-located router for transmission to the distribution server.

In some embodiments, the distribution server may be further configured to store the encoded streams for playback at a future point in time.

In some embodiments, the one or more remote camera units may include a wireless radio interface comprising multiple antennas, the multiple antennas having different polarities to provide a consistent wireless connection. In some embodiments, the one or more remote camera units may be further configured to transmit the compressed audio/video content via a plurality of associated wireless access points. In some embodiments, the one or more remote camera units may be configured to be powered using a 12-volt power interface.

In another embodiment, an apparatus is provided that at least includes a camera configured to capture an audio/video content stream; a converter configured to encode the captured audio/video content stream for transmission; a wireless radio interface configured to transmit the encoded audio/video content stream to a router through one or more local wireless access points, wherein the wireless radio interface comprises multiple antennas having different polarities to provide a consistent wireless connection; and a 12-volt power interface configured to provide power from a 12-volt power source to the video camera, the converter, and the wireless radio interface.

In some embodiments, the 12-volt power source may be provided by a vehicle alternator or an external battery and the 12-volt power interface converts the 12-volt power source for 12-volt power-over-Ethernet ports and 5-volt powered USB ports.

In some embodiments, the converter is further configured to buffer the captured audio/video content. In some embodiments, the converter comprises an H.263, H.264, or H.265 streaming video converter.

In some embodiments, the wireless radio interface is configured to operate at the highest legally-applicable power level.

In some embodiments, the apparatus may be further configured to transmit the encoded audio/video content via a plurality of associated wireless access points.

In another embodiment, a remote content streaming system is provided that at least includes a racing vehicle and a remote camera unit, wherein the remote camera unit is attached to the racing vehicle. The remote camera unit at least includes a camera configured to capture an audio/video content stream; a converter configured to encode the captured audio/video content stream for transmission; a wireless radio interface configured to transmit the encoded audio/video content stream, wherein the wireless radio interface comprises multiple antennas having different polarities to provide a consistent wireless connection; and a 12-volt power interface configured to provide power from a power system of the racing vehicle to the video camera, the video converter, and the wireless radio interface.

In some embodiments, the racing vehicle may be a motorcycle. In some embodiments, the multiple antennas of the wireless radio interface are configured to maintain consistent throughput for at least a 50-degree lean of the motorcycle.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a system for providing interactive content streaming from an event venue in accordance with an example embodiment of the present invention;

FIG. 2 is a block diagram of an apparatus for capturing and streaming video content in accordance with an example embodiment of the present invention;

FIG. 3a is a block diagram of an apparatus for transmitting streaming video from a venue in accordance with an example embodiment of the present invention;

FIG. 3b is a block diagram of an apparatus for encoding and transmitting streaming video from a venue in accordance with an example embodiment of the present invention;

FIG. 4 is an exemplary web-based interface providing delivery of content streams in accordance with an example embodiment of the present invention;

FIGS. 5a-d are flow charts illustrating operations performed in accordance with an example embodiment of the present invention; and

FIG. 6 is a block diagram of an apparatus that may be specifically configured in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the teen ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

Systems, apparatuses, and methods are provided according to example embodiments of the present invention to provide interactive content streaming systems configured to deliver video or audio and video (“audio/video”) content from one or more varieties of one or more of venues to event spectators.

Embodiments provide systems and methods for capturing, encoding, and transmitting compressed streams of digital video content or audio and video content from a variety of sites, such as from motorsports or racing venues, using one or more terrestrial-based network connections to a central distribution server, where the digital content may be presented to spectators using interfaces which allow the spectators to select from one or more streams of event activity from multiple sites.

In some embodiments, such audio/video streams may be captured and transmitted from a high-speed, moving vehicle, for example from a motorcycle, car, truck, boat, or the like, over long distances (e.g., up to one mile) using high-powered terrestrial-based wireless network technology in conditions which are traditionally not possible or considered to be marginal at best.

Many event venues have existing PA/Announcer audio equipment for local distribution of audio feeds with a variety of outputs, and current portable video cameras may provide digital video output. A number of solutions for encoding and compressing digital video streams for transmission, such as to the Internet, now exist, including H.264/MPEG-4 encoders. However, these existing systems often have limitations affecting the ability to provide content streaming including the technical expertise required to configure them as well as the limited input connections for audio and video available on the devices.

Additionally, transmitting real-time digital video over the Internet generally requires the use of a high-speed and low-latency broadband connection, such as a Digital Subscriber Line (DSL) or Cable Modem. Some existing streaming video systems are capable of utilizing a cellular 3G/4G data connection to transmit streams. These transmission solutions have a number of important limitations. For example, many event venues, such as motorsports sites, may be located in rural areas with limited access to terrestrial-based broadband networks and in marginal cellular service areas. As such, there is often a lack of sufficient bandwidth or consistent cellular signal for streaming digital content back to a distribution server.

Embodiments of the present invention provide for turn-key solutions at event venues for combining local audio feeds from PA/Announcer audio systems with captured digital audio/video and encoding, compressing, and transmitting the encoded digital audio/video streams. Embodiments provide for transmitting the encoded digital audio/video streams using one or more terrestrial-based network connections, such as via the Internet, to a central distribution system. The central distribution system may receive content (video streams or audio and video streams) from a plurality of event venues and provide distribution of the content to end-users (e.g., event spectators). In some embodiments, the central distribution system may provide one or more interfaces, such as an Internet-based centralized streaming content portal, allowing end-users to select from the one or more streams transmitted from one or more event venues.

Additionally, transmitting real-time video over the wireless spectrum requires a high-speed and low-latency connection, and therefore generally requires a consistent data connection with relatively little interference or noise. Such a connection, for example in an event venue, has typically had limited mobility, requiring the use of highly-directional antennas with line-of-sight between the wireless access point (WAP) and the client, often through costly methods such as the use of microwave or radio frequency (RF) transmission via an overhead crane, helicopter, or the like. Such connections are generally limited to hundreds of feet and require costly equipment.

Methods for transmitting video data from a moving vehicle using low cost, typical 802.11 wireless networks over long distances have previously proven ineffective, partially due to the fact that the client antenna mounted on the vehicle falls out of phase relative to the antenna of the WAP as the vehicle maneuvers through the turns of a race track, for example. Also, the power levels of typical 802.11 radios are often lower than the maximum level allowed by law. Additionally, there are a variety of voltage and amperage requirements necessary to power streaming video equipment. Consequently, embodiments of the present invention were developed to provide a reliable video stream using the commercially-available wireless spectrum, in marginal conditions, and at a reasonable cost.

### Exemplary Interactive Streaming Video System

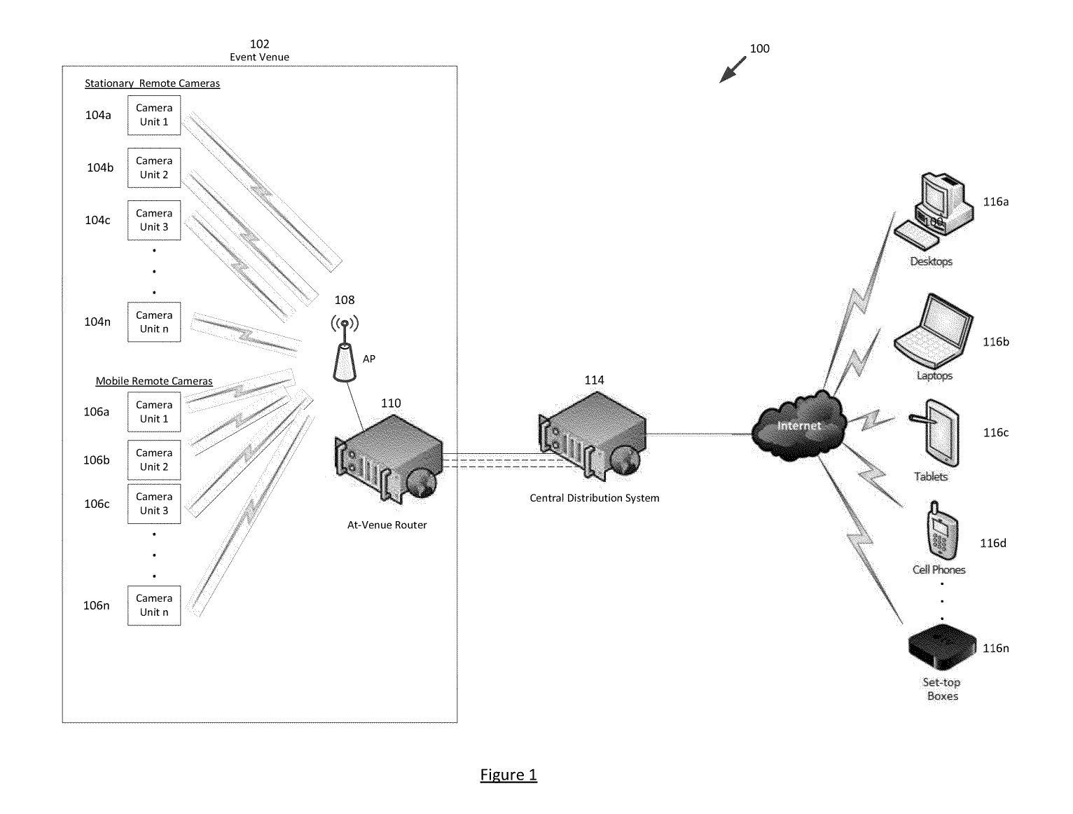

FIG. 1 illustrates an exemplary system for providing interactive content streaming of audio and video content from one or more varieties of one or more of venues to event spectators.

As illustrated in FIG. 1, a content streaming system, such as streaming system 100, may capture and process audio/video content at one or more event venues, such as racing or motorsports venues, and provide the content to a centralized distribution system which allows for the content to be distributed to a plurality of end-users, e.g., event spectators. Streaming system 100 is illustrated as configured to stream audio/video content being captured and transmitted from one event venue, venue 102, however streaming systems of the present embodiments may include content captured and transmitted from a plurality of venues to the same centralized distribution system.

At venue 102, one or more remote camera units, such as stationary camera units 104a-n and/or mobile camera units 106a-n, may be positioned within the venue 102 to capture audio/video content. For example, in a motorsports venue, stationary camera units 104a-n may be located in an announcer booth, in a press room, trackside, in pits, in vehicle haulers, etc., and may provide captured content from the plurality of locations to the streaming system 100. In a further example of a motorsports venue, mobile camera units 106a-n may be on-board camera units, e.g., positioned on racing vehicles such as motorcycles, cars, trucks, etc., or may be roving camera units for providing on-the-spot content, such as pit reports, etc.

The stationary camera units 104a-n and/or mobile camera units 106a-n may capture, encode, compress, and buffer live video content or audio and video content and transmit the encoded content to one or more on-site wireless access points (AP), such as AP 108. The AP 108 facilitates transmission of the encoded content from the remote camera units to a server or router located at the event venue, such as at-venue router 110. In some embodiments, a venue may have a single AP and all the remote camera units within the venue may transmit the encoded content using the single AP. In other embodiments, a venue may have multiple APs which may be associated and the remote camera units within the venue may transmit the encoded content using one of the multiple APs based on the position of the remote camera unit within the venue.

The at-venue router 110 receives the content streams from the plurality of remote camera units (stationary camera units 104a-n and/or mobile camera units 106a-n) for transmission to a central distribution system, such as central distribution system 114.

In some embodiments, the at-venue router 110 may be configured to receive location information, such as from a Global Positioning System (GPS) receiver, which may be included with the encoded content streams for use by the central distribution system. For example, in some embodiments, the central distribution system may use the location information provided with the content streams to tailor which content streams are provided to users, such as by identifying the user's location and providing a list of content streams being captured at locations nearby or based on other geographic limitations.

In some embodiments, the at-venue router 110 may comprise or be otherwise connected to a network routing device utilizing multiple internally-mounted data connection devices on separate networks for transmitting the digital streams from the venue to the central distribution system. For example, the network routing device may provide for the combining of multiple wide area network (WAN) connections, such as DSL/Cable Modem and multiple 3G/4G cellular data connections, for bonded distribution of data between two networks. As such, these embodiments may provide connections having the necessary bandwidth, speed, and reliability to allow for transmission of streaming content from event venues located in more rural environments.

In some embodiments, the streaming system 100 may optionally further comprise an at-venue encoding server (not shown) which may be configured to receive the content streams from the plurality of remote camera units as well as additional audio and/or video inputs, such as from an event venue announcer system or the like. The at-venue encoding server may combine the additional audio and/or video inputs with the content received from the remote camera units and encode the combined content into encoded content streams to be transmitted to the central distribution system through the at-venue router 110. In some embodiments, for example, the at-venue encoding server may comprise a streaming video encoder capable of combining audio/video feeds from multiple connections and encoding the audio/video streams using H.263/H.264/MPEG-4, or similar codecs.

The at-venue router 110 may transmit the plurality of encoded content streams to a central distribution system, such as central distribution system 114. The central distribution system 114 may receive content streams from a plurality of event venues and make the content streams available to users (e.g., event spectators), such as through user devices 116a-n for example.

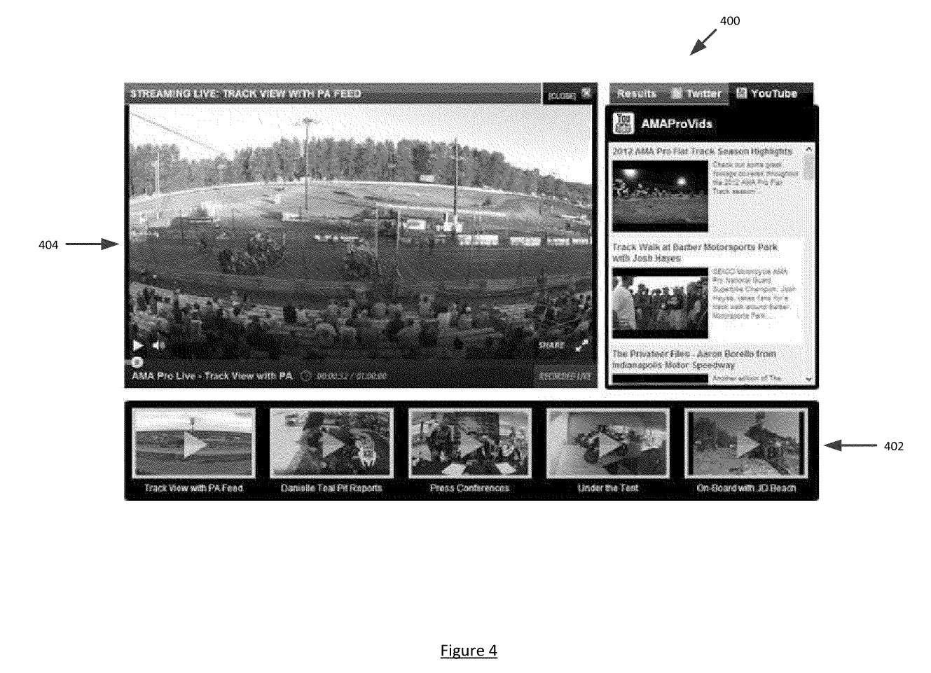

The central distribution system 114 may provide one or more web-based interfaces, such as a centralized streaming portal, for distribution of the content streams. Such a centralized streaming portal may provide for development of a recognizable brand for the streaming content. In some embodiments, the central distribution system 114 may receive the content streams from authorized sources, such as the at-venue router 110, and automatically enable links to the content streams on the web-based interface, such as the exemplary interface illustrated in FIG. 4. The web-based interface may provide a selection of streams from which a user may select one or more to display.

In some embodiments, the central distribution system 114 may provide a web-based interface allowing for the selection of a particular event venue site from a list of available venue sites and then display the content streams available from the selected venue site from which a user to select a content stream for display. In some embodiments, the central distribution system 114 may use GPS location data provided with the content streams in determining what content streams to provide to a user for selection. For example, the central distribution system 114 may request or determine geolocation information from the user device 116a-n, such as through the web-based interface, and use the user device location with the GPS location data of the content streams to display links on the web-based interface for content streams that are being captured at locations near the user device, or based on other geographic limitations.

In some embodiments, the central distribution system 114 may store the content streams from the plurality of event venues and provide links to the stored content such as through the web-based interface, for replay at a future point in time. The central distribution system 114 may also provide for the redistribution of the stored content streams to other platforms, such as by using Real Time Messaging Protocol (RTMP) or other streaming protocols. Additionally, in some embodiments, the central distribution system 114 may provide for distribution of the content streams through custom applications on mobile devices, such as smartphones, tablet devices, and the like. In some embodiments, the central distribution system 114 may provide “Shoulder Content” such as for television broadcasts.

### Exemplary Remote Camera Units

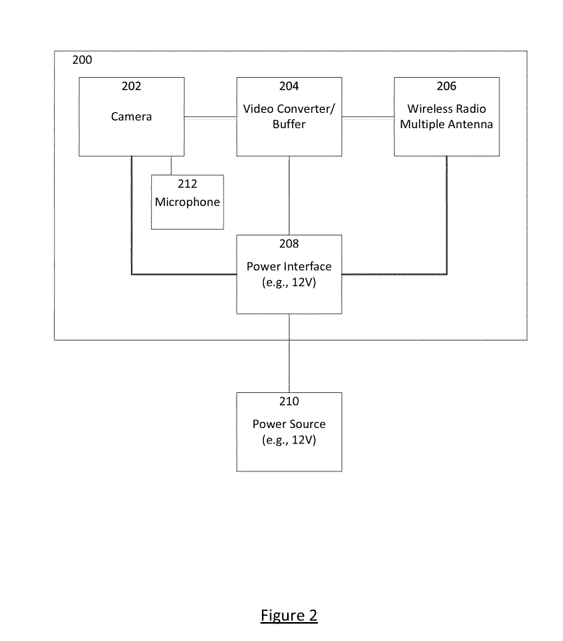

FIG. 2 illustrates a block diagram of an exemplary apparatus for capturing and streaming video content or audio and video content in accordance with an example embodiment of the present invention, such as remote camera units 104a-n and/or 106a-n illustrated in FIG. 1.

The remote camera unit 200 illustrated in FIG. 2 may comprise a streaming-capable video camera 202, a microphone 212, a video converter/buffer 204, a wireless radio interface 206, and a power interface 208.

In some embodiments, the devices comprising the remote camera unit 200 may all be powered by a 12-volt power source, such as 12-volt power source 210, through the power interface 208, which may be a 12-volt power interface. For example, the devices for video capture, encoding, compression and transmission may require constant, direct current voltages ranging from 5V to 12V, and current battery technology has a high weight-power capacity ratio which may prevent the use of independent battery sources for each device in some embodiments. In example embodiments, such as mobile camera units used in motorsports venues on race vehicles, the vehicle alternator creates a constant 12V power source while the vehicle is operational, and the power interface 208 may be a 12-volt power interface connected to the vehicle power system and convert the 12V power source from the vehicle's alternator for 12V power-over-Ethernet (POE) ports, possibly as well as 5V-powered USB ports. In other embodiments, the power source 210 may be provided by an external battery which is connected to the power interface 208 providing power to the remote camera unit.

The remote camera unit 200 may comprise a video camera 202 for capturing audio/video (e.g., video or video and audio) content that is to be streamed. The video camera may be configured to provide HDMI and/or component video outputs for use in the streaming system. The remote camera unit 200 may also comprise a microphone 212 which may be configured as part of the video camera 202 or externally to the video camera 202. For example, in some embodiments, such as a mobile remote camera unit used as a roving unit, the remote camera unit may comprise an external microphone, such as may be connected to the video camera 202, for capturing audio content. The video camera 202 may provide the captured audio/video content to a video converter/buffer 204 such as using an HDMI or component video output.

The remote camera unit 200 may comprise a video converter/buffer 204 to reduce the data overhead required to transmit the video content. Transmitting uncompressed video is a data-intensive process. As such, the video converter/buffer 204 may be used to encode and compress the video at the remote camera unit before transmission to the at-venue server or router of a streaming system. In some embodiments, the video converter/buffer 204 may comprise an H.263, H.264, or H.265 streaming video converter or the like. The video converter/buffer 204 may also comprise a data-buffering system to protect the system from data throughput limitations. The video converter/buffer 204 may provide the encoded content to a wireless radio interface 206.

The remote camera unit 200 may comprise a wireless radio interface 206 to provide for transmission of the encoded content to a server or router, such as the at-venue router 110 illustrated in FIG. 1.

Typical 802.11 wireless equipment is generally equipped with one single-phase antenna which can be positioned on either a vertical or horizontal azimuth. When a wireless radio interface is mounted on a vehicle such as a motorcycle, as the motorcycle leans at least 50 degrees as the vehicle navigates the turns of a race course, the client distribution antenna of the wireless radio interface leans out of phase relative to the wireless access point (WAP) antenna, resulting in marginal throughput conditions. As such, the remote camera unit 200 may comprise a wireless radio interface 206 with dual-polarity antennas to allow for consistent throughput across at least one of the two polarities, regardless of vehicle lean angle. In some embodiments, the wireless radio interface 206, as well as the wireless access point, may comprise a multiple-input and multiple-output (MIMO) wireless radio having multiple antennas to improve performance.

In some embodiments, the wireless radio interface 206 and the one or more wireless access points may be configured to use the highest legally-applicable power levels to allow for connectivity and transmission of the streaming content over greater distances, for example up to one mile over 2.4 GHz. For example, per Title 47 CFR Part 15 of the FCC rules, specifically Section 15.247(b)(3), systems using digital modulation in the 902-928 MHz, 2400-2483.5 MHz, and 5725-5850 MHz bands may use power levels of 1 Watt. (See http://www.ecfr.gov/cgi-bin/text-idx?c=ecfr&SID=622f68c8133fe455b19fc3e45bd04905&rgn=div8&view=text&node=4 7:1.0.1.1.16.3.234.31&idno=47)

### Exemplary At-Venue Routers/Servers

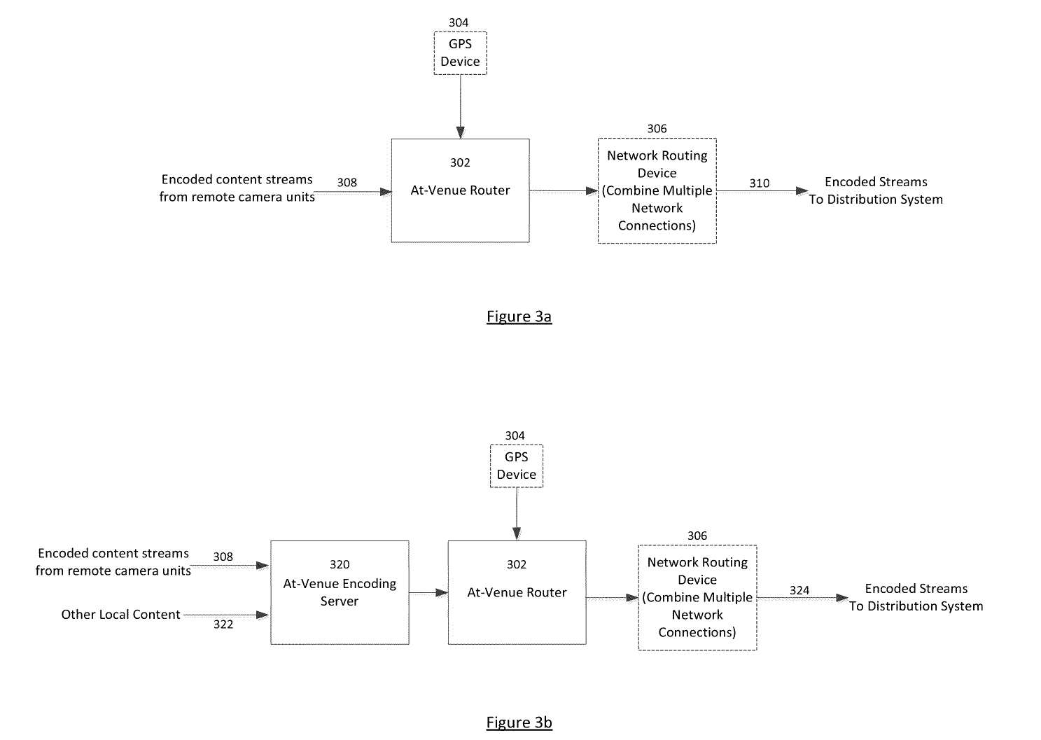

FIG. 3a illustrates a block diagram of an exemplary apparatus for transmitting streaming video content from a venue in accordance with an example embodiment of the present invention, such as at-venue router 110 illustrated in FIG. 1.

The at-venue router 302 of FIG. 3a may receive encoded audio/video content 308 from each of one or more remote camera units. The at-venue router 302 may transmit the encoded streams 310 to a distribution system, such as central distribution system 114 of FIG. 1.

In some embodiments, a GPS device 304 may be comprised within or operationally connected to the at-venue router 302. The GPS device 304 may provide location information which the at-venue router 302 may include with the transmission of the encoded streams to identify the location of the venue where the audio/video content is being captured.

In some embodiments, a network routing device 306 may be comprised within or operationally connected to the at-venue router 302. The network routing device 306 may provide for combining multiple network connections, such as DSL/Cable Modem and multiple 3G/4G cellular data connections, to provide sufficient bandwidth for the transmission of the encoded streams 310 to a distribution system, such as central distribution system 114 of FIG. 1.

FIG. 3b illustrates a block diagram of an exemplary apparatus for encoding and transmitting streaming video content from a venue in accordance with an example embodiment of the present invention.

The at-venue encoding server 320 of FIG. 3b may receive encoded audio/video content 308 from each of one or more remote cameras and may receive other local content 322 from sources other than the remote camera units, such as a venue announcer system or the like. The at-venue encoding server 320 may combine the encoded audio/video content 308 from each of the one or more remote camera units and other local content 322 and encode the combined content into the encoded streams 324 transmitted to the at-venue router 302.

In some embodiments, the at-venue encoding server may further allow for use of the content streams at the venue such as for near real-time display by a broadcast partner for example.

### Exemplary Web-Based Interface

FIG. 4 illustrates an exemplary web-based interface providing delivery of content streams in accordance with an example embodiment of the present invention. As disclosed herein, a central distribution system may receive a plurality of content streams from a plurality of event venues for distribution to spectators (users). In some embodiments, the central distribution system may provide a web-based interface, such as web-based interface 400, to allow a user to select one or more content streams for viewing. The web-based interface 400 may include links, which may comprise sample thumbnail images or video of the content, such as links 402, for a user to select from the available content streams. Upon receiving a selection of a content stream, the web-based interface 400 may cause the selected content stream to be played in a display window, such as window 404.

In some embodiments, the web-based interface 400 may first provide a user with a list of sites with available content streams, and upon receiving a selection of a site, provide a display of links for available content streams captured at the selected site. In some embodiments, the web-based interface 400 may use location data provided with the content streams and location data provided by a user device to select content streams being captured at one or more sites near the user's current location or based upon other geographic restrictions, and display links to those content streams.

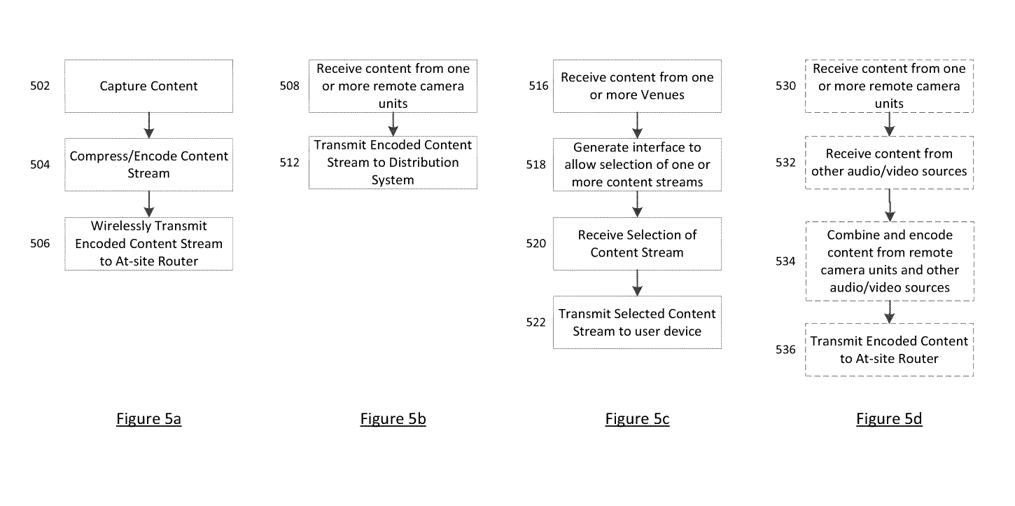

FIGS. 5a through 5d illustrate flow charts of operations which may be performed by a streaming system in accordance with an example embodiment of the present invention.

FIG. 5a illustrates operations which may be performed by a remote camera unit, such as remote camera unit 200 of FIG. 2 or stationary camera units 104a-n and/or mobile camera units 106a-n of FIG. 1, in some embodiments. As shown in block 502 of FIG. 5a, the remote camera unit 200 may include means, such as camera 202, to provide for capturing video content or audio and video content to be streamed. At block 504, the remote camera unit 200 may include means, such as video converter/buffer 204, to encode, compress, and buffer the captured content. At block 506, the remote camera unit 200 may include means, such as wireless radio interface 206, to cause the encoded content stream to be transmitted to a server or router, such as at-site router 110 of FIG. 1, such as through one or more wireless access points.

FIG. 5b illustrates operations which may be performed by a router, such as at-site router 110 of FIG. 1, in some embodiments. As shown in block 508 of FIG. 5b, the at-site router 110 may include means, such as a processor, communications interface, or the like, to receive one or more content streams from one or more remote camera units, such as remote camera unit 200 of FIG. 2. At block 510, the at-site router 110 may include means, such as a processor, memory, communications interface, or the like, to cause the one or more encoded content streams to be transmitted to a central distribution system, such as central distribution system 114 of FIG. 1.

FIG. 5c illustrates operations which may be performed by one or more servers, such as at the central distribution system 114 of FIG. 1, in some embodiments. As shown in block 516 of FIG. 5c, the central distribution system 114 may include means, such as a processor, communications interface, or the like, to receive one or more encoded content streams from one or more venues, such as via an at-site router 110 of FIG. 1. At block 518, the central distribution system 114 may include means, such as a processor, memory, or the like, for generating one or more interfaces, such as a central streaming portal or web site, to allow for selection of one or more of the content streams to be played. In some embodiments, the interface may provide for selection of a venue site from one or more available venue sites and then provide for selection of the content streams available from the selected venue site. At block 520, the central distribution system 114 may include means, such as a processor, memory, or the like, for receiving a selection of a content stream from a user device, such as one of user devices 116a-n of FIG. 1. At block 522, the central distribution system 114 may include means, such as a processor, memory, communication interface or the like, to cause the selected content stream to be transmitted to the user device for playback.

FIG. 5d illustrates optional operations which may be performed by a server, such as at-venue encoding server 320 of FIG. 3, in some embodiments. As shown in block 530 of FIG. 5d, the at-venue encoding server 320 may include means, such as a processor, communications interface, or the like, to receive one or more content streams from one or more remote camera units, such as remote camera unit 200 of FIG. 2. At block 532, the at-venue encoding server 320 may include means, such as a processor, communications interface, or the like, to receive audio/video content from sources other than the one or more remote units, such as a venue announcer system or the like. At block 534, the at-venue encoding server 320 may include means, such as a processor, memory, or the like, to combine the content received from one of the one or more remote camera units with the audio/video content from the other sources and encode the combined content. At block 536, the at-venue encoding server 320 may include means, such as a processor, memory, communications interface, or the like, to cause the one or more encoded content streams to be transmitted to an at-venue router, such as at-venue router 110 of FIG. 1.

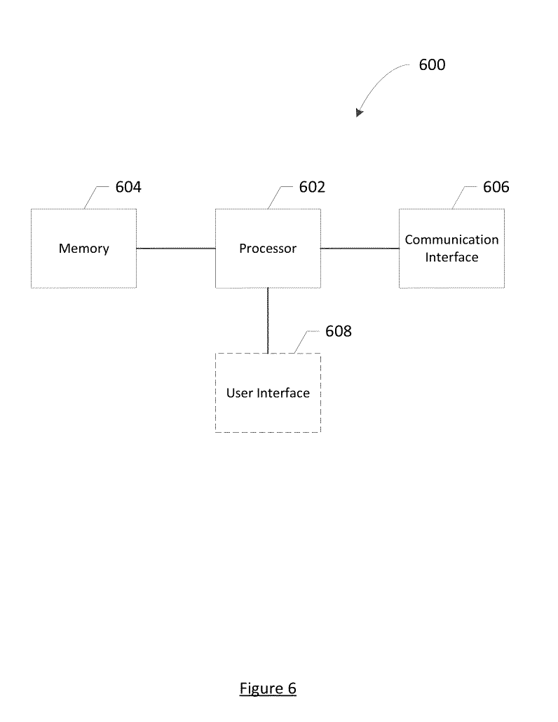

A system of an embodiment of the present invention may include one or more apparatus 600 as generally described below in conjunction with FIG. 6 for performing one or more of the operations set forth by FIGS. 1 through 5 described herein.

It should also be noted that while FIG. 6 illustrates one example of a configuration of an apparatus 600, numerous other configurations may also be used to implement other embodiments of the present invention. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

FIG. 6 illustrates a block diagram of components that may be included in an apparatus that may provide operations in accordance with embodiments discussed herein. Apparatus 600 may comprise one or more processors, such as processor 602, one or more memories, such as memory 604, one or more communication interfaces, such as communication interface 606, and user interface 608. Processor 602 can be, for example, a microprocessor that is configured to execute software instructions and/or other types of code portions for carrying out defined steps, some of which are discussed herein. Processor 602 may communicate internally using a data bus. The data bus can be used to convey data, including program instructions, between processor 602 and memory 604.

It should also be noted that while FIG. 6 illustrates one example of a configuration of an apparatus 600, numerous other configurations may also be used to implement other embodiments of the present invention. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

Memory 604 may include one or more non-transitory storage media such as, for example, volatile and/or non-volatile memory that may be either fixed or removable. Memory 604 may be configured to store information, data, applications, instructions or the like for enabling apparatus 600 to carry out various functions in accordance with example embodiments of the present invention. For example, the memory could be configured to buffer input data for processing by processor 602. Additionally or alternatively, the memory could be configured to store instructions for execution by processor 602. Memory 604 can be considered primary memory and be included in, for example, RAM or other forms of volatile storage which retain its contents only during operation, and/or memory 604 may be included in non-volatile storage, such as ROM, EPROM, EEPROM, FLASH, or other types of storage that retain the memory contents independent of the power state of apparatus 600. Memory 604 could also be included in a secondary storage device, such as external disk storage, that stores large amounts of data. In some embodiments, the disk storage may communicate with processor 602 using an input/output component via a data bus or other routing component. The secondary memory may include a hard disk, compact disk, DVD, memory card, or any other type of mass storage type known to those skilled in the art.

In some embodiments, processor 602 may be configured to communicate with external communication networks and devices using communications interface 606, and may use a variety of interfaces such as data communication oriented protocols, including X.25, ISDN, DSL, among others. Communications interface 606 may also incorporate a modem for interfacing and communicating with a standard telephone line, an Ethernet interface, cable system, and/or any other type of communications system. Additionally, processor 602 may communicate via a wireless interface that is operatively connected to communications interface 606 for communicating wirelessly with other devices, using for example, one of the IEEE 802.11 protocols, 802.15 protocol (including Bluetooth and the like), a cellular protocol (Advanced Mobile Phone Service or “AMPS”), Personal Communication Services (PCS), or a standard 3G/4G wireless telecommunications protocol, such as CDMA2000 1x EV-DO, GPRS, W-CDMA, LTE, and/or any other protocol.

The apparatus 600 may include a user interface 608 that may, in turn, be in communication with the processor 602 to provide output to the user and, in some embodiments, to receive an indication of a user input. For example, the user interface may include a display and, in some embodiments, may also include a keyboard, a mouse, a joystick, a touch screen, touch areas, soft keys, a microphone, a speaker, or other input/output mechanisms. The processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor (e.g., memory 604, and/or the like).

As described above, FIGS. 5a through 5c illustrate flowcharts of a system, apparatus, and method according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 604 of an apparatus employing an embodiment of the present invention and executed by a processor 602 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, such as shown by the blocks with dashed outlines. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A system comprising:
a distribution server; and
one or more venue systems, each located at a site and each comprising:
one or more remote camera units;
one or more wireless access points; and
a site-located router;
the one or more remote camera units at least configured to:
capture audio/video content;
encode and buffer the captured audio/video content; and
transmit the encoded audio/video content to the site-located router via the one or more wireless access points;
the site-located router at least configured to:
receive one or more streams of encoded audio/video content from the one or more remote camera units;
and
transmit the encoded streams to the distribution server;
the distribution server at least configured to:
receive one or more encoded streams from the one or more venue systems;
provide an interface for the selection of one of the one or more encoded streams; and
transmit the selected encoded stream to a user device.

2. The system of claim 1 wherein the site-located router is further configured to combine multiple network connections for transmitting the one or more encoded streams to the distribution server.

3. The system of claim 1 wherein the interface provides for the selection of one of the one or more sites and then provides for selection of the one or more encoded streams transmitted from the selected site.

4. The system of claim 1, wherein the one or more venue systems further comprises a Global Positioning System device configured to provide location data to be transmitted along with the one or more encoded streams to the distribution server, and the distribution server further configured to provide the interface for the selection of one of the one or more encoded streams, the interface displaying the one or more encoded streams for selection based in part on the location data.

5. The system of claim 1 further comprising a site-located encoding server at least configured to:
receive one or more streams of encoded audio/video content from the one or more remote camera units;
receive other audio/video content from one or more sources other than the one or more remote camera units;
combine the other audio/video content with one or more of the streams of encoded audio/video content from the one or more remote camera units;
encode the combined content; and
transmit the encoded content to the site-located router for transmission to the distribution server.

6. The system of claim 1, wherein the distribution server is further configured to store the encoded streams for playback at a future point in time.

7. The system of claim 1, wherein the one or more remote camera units comprise a wireless radio interface comprising multiple antennas, the multiple antennas having different polarities to provide a consistent wireless connection.

8. The system of claim 1, wherein the one or more remote camera units are further configured to transmit the compressed audio/video content via a plurality of associated wireless access points.

9. The system of claim 1, wherein the one or more remote camera units are configured to be powered using a 12-volt power interface.

10. An apparatus comprising:
a camera at least configured to capture an audio/video content stream;
a converter at least configured to encode the captured audio/video content stream for transmission;
a wireless radio interface at least configured to transmit the encoded audio/video content stream to a router through one or more local wireless access points, wherein the wireless radio interface comprises multiple antennas having different polarities to provide a consistent wireless connection; and
a 12-volt power interface at least configured to provide power from a 12-volt power source to the camera, the converter, and the wireless radio interface.

11. The apparatus of claim 10, wherein the 12-volt power source may be provided by a vehicle alternator or an external battery and the 12-volt power interface converts the 12-volt power source for 12-volt power-over-Ethernet ports and 5-volt powered USB ports.

12. The apparatus of claim 10, wherein the video converter is further configured to buffer the encoded audio/video content.

13. The apparatus of claim 10, wherein the wireless radio interface is further configured to operate at the highest legally-applicable power level.

14. The apparatus of claim 10, wherein the converter comprises an H.263, H.264, or H.265 streaming video converter.

15. The apparatus of claim 10, the apparatus further configured to transmit the encoded audio/video content via a plurality of associated wireless access points.

16. A remote content streaming system comprising:
a racing vehicle; and
a remote camera unit, wherein the remote camera unit is attached to the racing vehicle, the remote camera unit comprising:
a camera at least configured to capture an audio/video content stream;
a converter at least configured to encode the captured audio/video content stream for transmission;
a wireless radio interface at least configured to transmit the encoded audio/video content stream, wherein the wireless radio interface comprises multiple antennas having different polarities to provide a consistent wireless connection; and
a 12-volt power interface at least configured to provide power from a power system of the racing vehicle to the camera, the converter, and the wireless radio interface.

17. The remote content streaming system of claim 16, wherein the racing vehicle is a motorcycle.

18. The remote content streaming system of claim 16, wherein the multiple antennas of the wireless radio interface are at least configured to maintain consistent throughput for at least a 50-degree lean of the motorcycle.

19. The remote content streaming system of claim 16, wherein the converter is further configured to buffer the encoded audio/video content.

20. The remote content streaming system of claim 16 further configured to transmit the encoded audio/video content via a plurality of associated wireless access points.
